(19) United States
(12) Patent Application Publication
(10) Pub. No.: US 2014/0188999 A1
(43) Pub. Date: Jul. 3, 2014

(54) METHODS, SYSTEMS, AND DEVICES FOR COMMUNICATION BETWEEN A VEHICLE SERVICE CENTER AND A MOBILE COMPUTING DEVICE

(71) Applicants: Tom Leonard, Jacksonville, FL (US); Aasif Bagdadi, Jacksonville, FL (US)

(72) Inventors: Tom Leonard, Jacksonville, FL (US); Aasif Bagdadi, Jacksonville, FL (US)

(73) Assignee: DMEAUTOMOTIVE, Daytona Beach, FL (US)

(21) Appl. No.: 13/733,020

(22) Filed: Jan. 2, 2013

(51) Int. Cl. H04L 12/58

(52) U.S. Cl. CPC H04L 51/00
USPC 709/204

(57) ABSTRACT

Methods, systems, and devices for providing a vehicle status to a mobile computing device are disclosed herein. A system for providing vehicle status to a mobile computing device includes a contact module, a status determination module, and a communication module. The contact module determines contact information associated with a vehicle scheduled for service at a vehicle service center. The contact information corresponds to a mobile computing device. The status determination module determines a status of the vehicle. The communication module communicates the status of the vehicle to the mobile computing device.

### TECHNICAL FIELD

The present disclosure relates communication between a vehicle service center and a mobile computing device and more particularly relates to providing status information regarding a vehicle service appointment to a mobile computing device.

### BRIEF DESCRIPTION OF THE DRAWINGS

FIGS. 1A and 1B are schematic diagrams of example systems for providing communication between a vehicle service center and a mobile computing device consistent with embodiments disclosed herein.

FIG. 2 is a schematic block diagram of a vehicle status system consistent with embodiments disclosed herein.

FIG. 3 is a schematic block diagram of a mobile status module of a mobile computing device consistent with embodiments disclosed herein.

FIG. 4 illustrates a screen shot of a home screen interface consistent with embodiments disclosed herein.

FIG. 5 illustrates a screen shot of an appointment interface consistent with embodiments disclosed herein.

FIGS. 6A-6J illustrate screen shots of a new appointment interface consistent with embodiments disclosed herein.

FIG. 7 illustrates a screen shot of a status interface consistent with embodiments disclosed herein.

FIG. 8 illustrates a screen shot of the status interface of FIG. 7 after a status update consistent with embodiments disclosed herein.

FIG. 9 illustrates a screen shot of a recommended services interface consistent with embodiments disclosed herein.

FIG. 10 illustrates a screen shot of a chat interface consistent with embodiments disclosed herein.

FIG. 11 illustrates a screen shot of the status interface of FIGS. 7 and 8 after another status update consistent with embodiments disclosed herein.

FIG. 12 illustrates a screen shot of a shuttle location interface consistent with embodiments disclosed herein.

FIG. 13 is a schematic flow chart diagram illustrating a method for providing a vehicle status to a mobile computing device consistent with embodiments disclosed herein.

FIG. 14 is a schematic flow chart diagram illustrating another method for providing a vehicle status to a mobile computing device consistent with embodiments disclosed herein.

FIG. 15 is a schematic flow chart diagram illustrating a method for presenting a vehicle status on a mobile computing device consistent with embodiments disclosed herein.

### DETAILED DESCRIPTION OF PREFERRED EMBODIMENTS

Repair shops, vehicle maintenance centers and other vehicle service centers provide important and often necessary maintenance, repair, or other services for customer's vehicles. Customers of repair shops, maintenance centers, and other vehicle service centers often depend on their vehicles as a significant part of daily life. For example, customers depend on their vehicles to safely and dependably transport themselves, their families, their customers, and/or goods to various locations. Failure of a vehicle or large amounts of time without the vehicle can be stressful, financially damaging, or even dangerous for the customer and others.

Because vehicle service centers provide services that are so important to customers, the communication, quality of customer service, and timeliness provided regarding vehicle services are very important for success of a vehicle service center. Furthermore, this importance to customers indirectly and/or directly leads to large amounts of phone calls, questions, and other queries for information fielded by employees. The resulting demand on employees can lead to a significant utilization of employee's time including skilled technicians, managers, service representatives or other service center employees. If a service center is under-staffed, long lines, frustration, and/or loss of business may result. However, employing additional employees can eat away at the profitability of the service center.

Some of the most frequent questions and phone calls fielded by employees at service centers include questions about the status of a vehicle, when a service will be finished, and/or when a shuttle will arrive. Additionally, technicians or other employees may often need to contact a customer to discuss the state of a vehicle, needed additional services or repairs, customer concerns, or other matters with customers. Both customers and service technicians are often unavailable and significant amounts of time are wasted when parties are not reachable. For example, multiple call attempts, time spent leaving messages, and time spent switching tasks can pull skilled technicians and mechanics from other duties and significantly reduce the amount of services a shop can provide in a given time period. Customers can be similarly affected as they take time out of their days to work with a vehicle service center to get needed services or repairs for their vehicle.

In view of the foregoing, the applicants have recognized that a need exists for efficient communication between a vehicle service center and a customer. The present disclosure sets forth various systems, apparatuses, and methods for providing communication between a mobile computing device and a vehicle service center. In one embodiment, a contact module determines contact information associated with a vehicle that is scheduled for service at a vehicle service center. The contact information may correspond to a mobile computing device. A status determination module determines the status of the vehicle and a communication module communicates the status to the mobile computing device.

A detailed description of systems and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

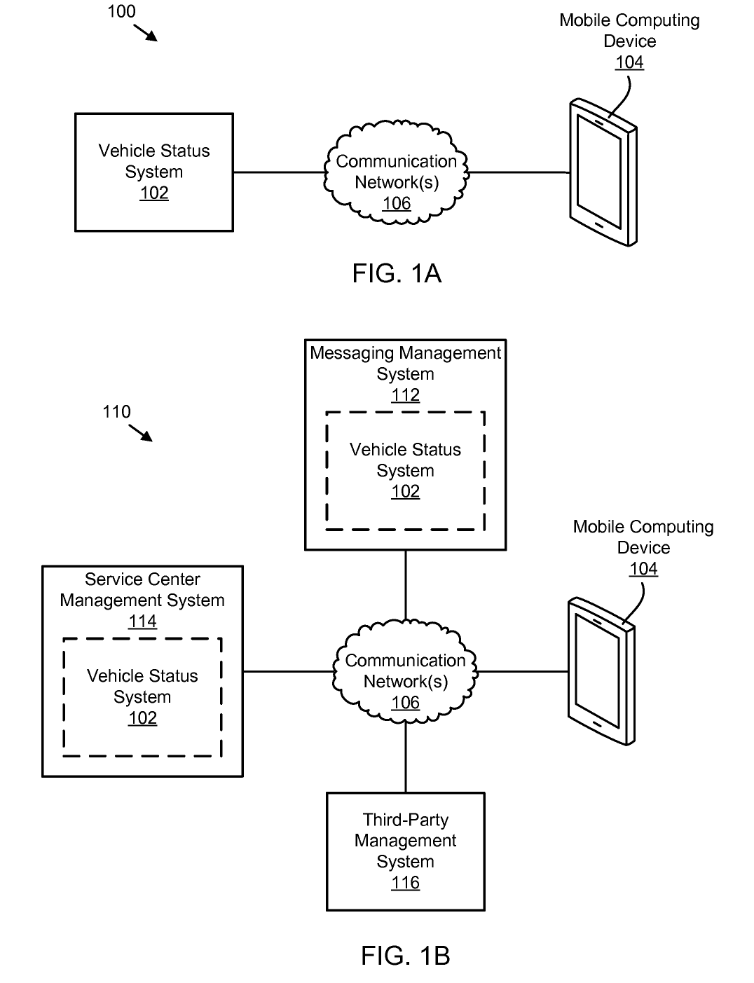

FIG. 1A is a schematic diagram of an example of a system 100 for providing communication between a vehicle service center and a mobile computing device 104. The system 100 includes a vehicle status system 102, a mobile computing device 104, and a communications network 106. According to one embodiment, the vehicle status system 102 is configured to communicate with the mobile computing device 104 to provide service status information and/or other information regarding a vehicle service appointment to a user of the mobile computing device 104.

The mobile computing device 104 may include a smart phone, tablet computer, or any other mobile computing device. In one embodiment, for example, the mobile computing device 104 may be running a mobile operating system such as Android®, iOS®, Windows Phone®, or any other mobile operating system. The mobile computing device 104 may be configured to communicate over a wireless network such as a mobile communications network, cellular network, or another wireless network.

In one embodiment, the mobile computing device 104 may include a mobile application that receives vehicle status information and renders the status for a user. The mobile computing application may also provide functions for scheduling an appointment, viewing the location of a shuttle, paying for service via the mobile computing device 104, searching vehicle inventory of a dealership, and/or the like. In one embodiment, the mobile computing application comprises code installed and/or executed natively on the mobile computing device 104.

FIG. 1B is a schematic diagram of another example of a system 110 for providing communication between a vehicle service center and a mobile computing device 104. Similar to the system 100 of FIG. 1A, the system 110 includes a vehicle status system 102, a mobile computing device 104, and a communications network 106. However, the system 110 also includes a messaging management system 112, a service center management system 114, and a third-party management system 116. According to varying embodiments, a vehicle status system 102 may be included as a part of one or more of the messaging management system 112 and the service center management system 114.

The messaging management system 112 may manage messaging or communication to a mobile computing device 104. In one embodiment, the messaging management system 112 may manage communication between the vehicle status system 102 and a mobile computing device 104 and/or between the service center management system 114 and a mobile computing device. In one embodiment, the messaging management system 112 provides vehicle lifecycle messages, sales promotions, or other communication services to a mobile computing device.

The service center management system 114 may include a system for managing operation of a vehicle service center. For example, the service center management system 114 may be used to manage a repair shop, maintenance center or other service center. In one embodiment, a service center may be located within an automotive dealership. In one embodiment, the service center management system 114 may be owned by a vehicle service center and may include scheduling, payment, and record keeping functions. In one embodiment, the service center management system 114 may provide service history information, purchase information, or other details to the messaging management system 112 to allow for more intelligent and targeted lifecycle messages, promotional messages, or other services. In one embodiment, the service center management system 114 maintains a vehicle service account with information regarding past services performed on a vehicle owned by a user of the mobile computing device 104. The service center management system 114 may provide other information, such as a purchase history or messages submitted by a dealer for sending to one or more customers.

The third-party management system 116 provides information about a vehicle owned by the user of the mobile computing device 104 to the messaging management system 112 and/or the mobile computing device 104. For example, the third-party management system 116 may provide information regarding recalls for a vehicle from a manufacturer. In one embodiment, the third-party management system 116 may make a vehicle application programming interface (API) available to the messaging management system 112 and/or the mobile computing device 104 to allow them to interface with a vehicle. For example, messages may be sent through the vehicle API to determine a location of the vehicle, remotely start the vehicle, remotely unlock the vehicle, or provide other functions.

The messaging management system 112, service center management system 114, mobile computing device 104, and/or third-party management system 116 are configured to communicate over the communication network 106. The network 106 may include one or more mobile communications networks, local area networks (LANs), wide area networks (WAN), the Internet, backbone communication networks, and/or various other networks.

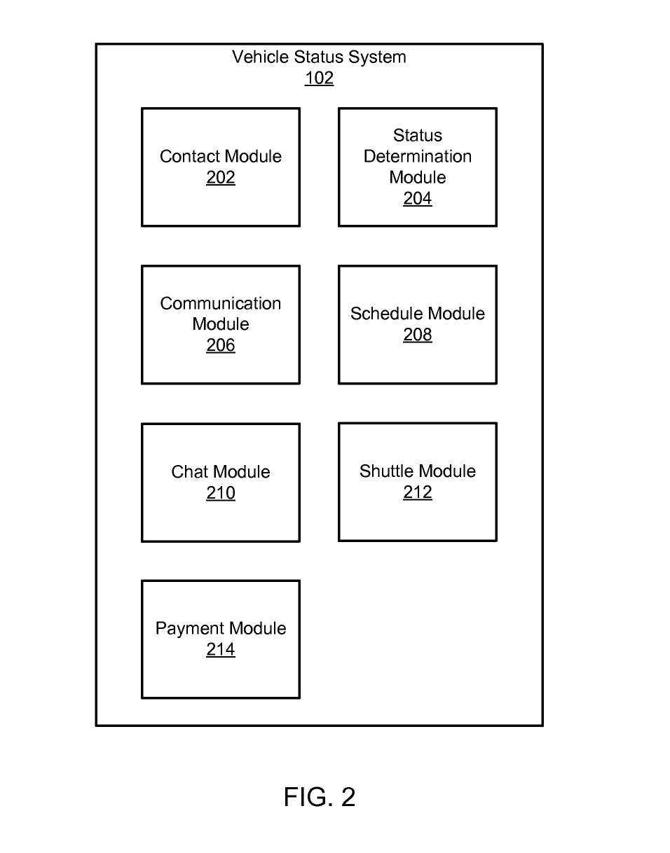

FIG. 2 is a schematic block diagram illustrating one embodiment of a vehicle status system 102. The vehicle status system 102 includes a contact module 202, a status determination module 204, a communication module 206, a schedule module 208, a chat module 210, a shuttle module 212, and a payment module 214. The modules 202, 204, 206, 208, 210, 212, and 214 are exemplary only, and varying embodiments may include only one or any combination of two or more of the modules 202, 204, 206, and 208 without limitation. In one embodiment, a vehicle status system 102 may only include a contact module 202, a status determination module 204, and/or a communication module 206. Other embodiments may include fewer, alternate, or additional modules.

The contact module 202 determines contact information associated with a vehicle scheduled for service at a vehicle service center. As used herein, the terms service or vehicle service are given to mean any type of maintenance, repair, or other service provided in relation to a vehicle. Examples of vehicle service include routine maintenance such as oil changes, tire rotations, and the like. In one embodiment, the contact information corresponds to a mobile computing device 104. For example, the contact information may include account information linked to a mobile computing device 104. The mobile computing device 104 may include a mobile application that has been registered using a specific account, and the account information corresponding to that account may be located by the contact module 202. The account may include an account registered with the messaging management system 112, service center management system 114, third-party management system 116, or any other user account.

In one embodiment, the contact information comprises contact information stored in a vehicle service account. For example, a service center management system 114 may maintain vehicle service accounts for each individual or each vehicle that it services. The vehicle service account may include account information or other information for identifying and communicating with a mobile computing device 104. In one embodiment, the contact information may correspond to a specific individual.

The contact module 202 may determine contact information based on vehicle or owner information. For example, the contact module 202 may locate contact information corresponding to one or more of a make, model, owner name, address, or other information. The contact module 202 may determine the contact information based on information managed by a messaging management system 112, a service center management system 114, or a third-party management system 116.

The status determination module 204 determines a status of a vehicle. The status determination module 204 may determine the status based on many types of information. In one embodiment, the status determination module 204 may receive status information provided by a technician. For example, a technician at a vehicle service center may enter status information for a vehicle or service each time a service begins, is completed, or scheduled. In one embodiment, the technician may enter information regarding additional needed services and the status determination module 204 may determine that these services are not scheduled. Additionally, one or more sensors, or other devices, may determine a location of the vehicle within the service center and automatically update a status of the vehicle or one or more services scheduled or suggested for the vehicle.

In one embodiment, the status of the vehicle includes a completion status of the vehicle. For example, the status may include a status indicating that the vehicle is finished, is waiting to be service, or is currently being serviced. The status may indicate to an owner whether the vehicle is ready to be driven or picked up. In one embodiment, the status of the vehicle determined by the status determination module 204 may include information regarding specific services. For example, a number of services may be scheduled for a vehicle and the status determination module 204 may determine a status for each service indicating that a specific service is finished, currently being performed, or not yet started.

In one embodiment, the status determination module 204 determines a completion time for a service or the vehicle. For example, the status determination module 204 may predict when the vehicle or service will be finished based on a type of service, a number of services, a number of other vehicles being serviced, and other information. The status determination module 204 may also determine a status comprising or indicating a location of the vehicle within the service center. For example, the status information may indicate that the vehicle is on a lift, positioned over a service pit, or waiting in a parking lot.

The status determination module 204 may determine a status that includes a suggested service. For example, if a technician indicates that an additional, unscheduled service is needed, the status may include information regarding the needed service.

The communication module 206 communicates information regarding the vehicle or a vehicle service appointment to a mobile computing device 104. The communication module 206 may communicate the information to a mobile computing device 104 that corresponds to the contact information determined by the contact module 202. The communication module 206 may communicate the information to the mobile computing device 104 using push, pull, or other types of messages. For example, the communication module 206 may communicate information to a location indicated by user account information and the mobile computing device 104 may receive the message or periodically fetch new messages corresponding to the account.

In one embodiment, the communication module 206 communicates the information to the mobile computing device 104 in real-time. For example, the communication module 206 may communicate the information from the vehicle service center such that the mobile computing device 104 receives the information within a specific time frame. The time frame may vary considerably from less than a second to minutes in length. In one embodiment, the communication module 206 communicates a status determined by the status determination module 204 within a very short time frame and it may be up to a communication network, one or more servers, and/or the mobile computing device 104 as to how soon the information is received by the mobile computing device 104.

The communication module 206 may communicate information to the mobile computing device 104 using a variety of methods or systems known in the art. For example, the status or other information may be communicated using internet protocol (IP) or any other data communication protocol. The communication module 206 may communicate information to the mobile computing device 104 via a messaging management system 112. In one embodiment, the communication module 206 may participate in a communication session between the vehicle status system 102 and the mobile computing device 104.

In one embodiment, the communication module 206 communicates the status of a vehicle or service to the mobile computing device 104. For example, each time the status determination module 204 determines a new status for a vehicle or service, the communication module 206 may communicate the new status to the mobile computing device 104. Thus, the communication module 206 may repeatedly communicate the status of a vehicle or service during a duration of a service appointment.

The communication module 206 may also receive information from the mobile computing device 104. In one embodiment, the communication module 206 may receive a request or confirmation for additional services. For example, the communication module 206 may send information regarding a suggested service, as determined by the status determination module 204, and receive from the mobile device 104 an approval for the performing of the suggested service. In another embodiment, the received information may include information corresponding to a request to schedule an appointment, a chat session with an employee at a vehicle service center, or the like.

The schedule module 208 schedules a service appointment at a vehicle service center. In one embodiment, the schedule module 208 communicates with the mobile computing device 104 to allow a user to schedule a service appointment. For example, the schedule module 208 may receive information regarding a vehicle and an owner and provide information about available appointment times and types of service. In one embodiment, a user may be able to schedule an appointment from the mobile computing device 104 and specify the types of services needed.

The chat module 210 processes information related to a chat session between a vehicle service center and the mobile computing device 104. The chat module 210 may receive text corresponding to a chat session from the mobile computing device 104 and send text corresponding to the chat session to the mobile computing device 104. For example, a service center employee may enter text which the chat module 210 sends to the mobile computing device 104 via the communication module 206 and receives, via the communication module 206, information entered by a user from the mobile computing device 104. In addition to processing text information, the chat module 210 may also send or receive image, audio, or video files. These files may allow a user to see issues with a vehicle that a technician would like to discuss.

Providing a chat session between an employee and user of the mobile computing device 104 may allow for many of the issues and questions to be answered by an employee at a convenient time without drawing a mechanic or other technician from other tasks at unpredictable times. Additionally, real-time communication through the chat and the ability to respond when convenient and simultaneously carry on multiple chats at the same time may save large amounts of time spent communicating and attempting to communicate by phone.

The shuttle module 212 provides information regarding a shuttle to be communicated to the mobile computing device 104. In one embodiment, the shuttle module 212 may receive information from a global positioning system (GPS) or other positioning system on a shuttle vehicle that indicates the location of the shuttle. The shuttle module 212 may provide this location information to the mobile computing device 104 which may allow a user to know when a shuttle is getting close.

In one embodiment, the shuttle module 212 may predict an arrival time at the individual's location based on a current location of the vehicle, and one or more other intermediate destinations. For example, if a shuttle is scheduled to pick up other customers in addition to the user, the shuttle module 212 may take into account a route and destinations the shuttle may travel prior to picking up the user.

The payment module 214 receives payment information from the mobile computing device 104. The payment module 214 may receive payment details for processing or may receive confirmation that payment for services has been sent. In one embodiment, the payment module 214 may provide information to the mobile computing device 104 prompting the user to pay. For example, the payment module 214 may provide the prompt in response to the vehicle service being finished. The user may then be able to initiate payment to the vehicle service center so that the user does not need to wait in line to pay upon arrival at the vehicle service center.

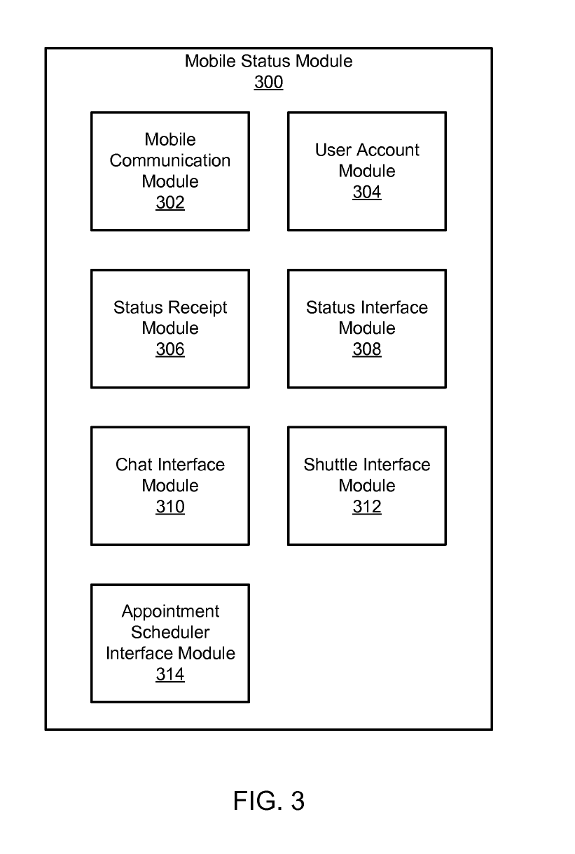

FIG. 3 is a schematic block diagram illustrating one embodiment of a mobile status module 300 of a mobile computing device 104. The mobile status module 300 includes a mobile communication module 302, a user account module 304, a status receipt module 306, a status interface module 308, a chat interface module 310, a shuttle interface module 312, and an appointment scheduler interface module 314. The modules 302, 304, 306, 308, 310, and 312 are exemplary only, and varying embodiments may include only one or any combination of two or more of the modules without limitation. In one embodiment, the mobile status module 300 includes code running on the mobile computing device 104. For example, the mobile status module 300 may include a mobile application installed on the mobile computing device 104.

The mobile communication module 302 is configured to communicate with a vehicle service center. The mobile communication module 302 may be configured to use a radio of the mobile computing device 104 to communicate wirelessly with the vehicle service center. In one embodiment, the mobile communication module 302 is configured to communicate with a vehicle service center via a messaging management system 112 and/or a service center management system 114. The mobile communication module 302 may receive and/or retrieve messages from a vehicle service center in real-time. For example, the mobile communication module 302 may retrieve messages or information sent by one or more of the vehicle status system 102, messaging management system 112, service center management system 114, and the third-party management system 116.

The user account module 304 stores account information corresponding to one or more vehicles. In one embodiment, the user account module 304 links the mobile status module 300 and/or a mobile computing device 104 to a specific account. In one embodiment, information corresponding to the user account stored by the use account module 304 is determined to be contact information by the contact module 202 of the vehicle status system 102.

The status receipt module 306 receives a status of a vehicle from a vehicle service center. For example, the status receipt module 306 receives the status determined by the status determination module 204 and sent by the communication module 206. The status may correspond to a vehicle scheduled for service at the vehicle service center. The status receipt module 306 may receive information in a push message, pull message, or other message type.

The status interface module 308 presents the status of the vehicle to a user on the mobile computing device 104. In one embodiment, the status is presented within a status interface on a display of the mobile computing device 104. The status interface may include various fields indicating a status of the vehicle, a predicted completion time, a status of a scheduled service, a suggested service, and/or other information. In one embodiment, the status interface module 308 provides a status interface that includes an option to initiate a chat with an employee at the vehicle service center. In another embodiment, a payment option, an option to view shuttle information, or other options are also displayed. In one embodiment, the payment option, shuttle information, or other information or options are displayed in response to receiving information indicating that service on the vehicle is finished.

The chat interface module 310 provides a chat interface to allow a user to participate in a chat session with an employee at a vehicle service center. For example, the chat interface may show text or files sent between parties and indicate the sender. The chat interface may also provide a text entry field to allow the user to enter text to be sent to the vehicle service center. In one embodiment, an attachment option may be used to attach an image, audio, video, or other file.

The shuttle interface module 312 provides a shuttle location interface that displays information regarding a location of a shuttle. The shuttle interface module 312 may receive shuttle location information from the vehicle status system 102 and display this information for a user. In one embodiment, the shuttle location interface may include a map with an indication of the location of the shuttle. A location of the user or mobile computing device 104 may also be indicated. In one embodiment, an estimated arrival time for the shuttle is provided on the shuttle interface module 312.

The appointment scheduler interface module 314 provides a scheduler interface to allow a user to schedule a service appointment with a mobile computing device 104. The appointment scheduler interface 314 may receive information regarding available services, available appointment times, or other information from a vehicle service center and allow the user to select from available options. The appointment scheduler interface module 314 may provide the details selected or entered by the user to the mobile communication module 302 to be communicated to the vehicle status module 300.

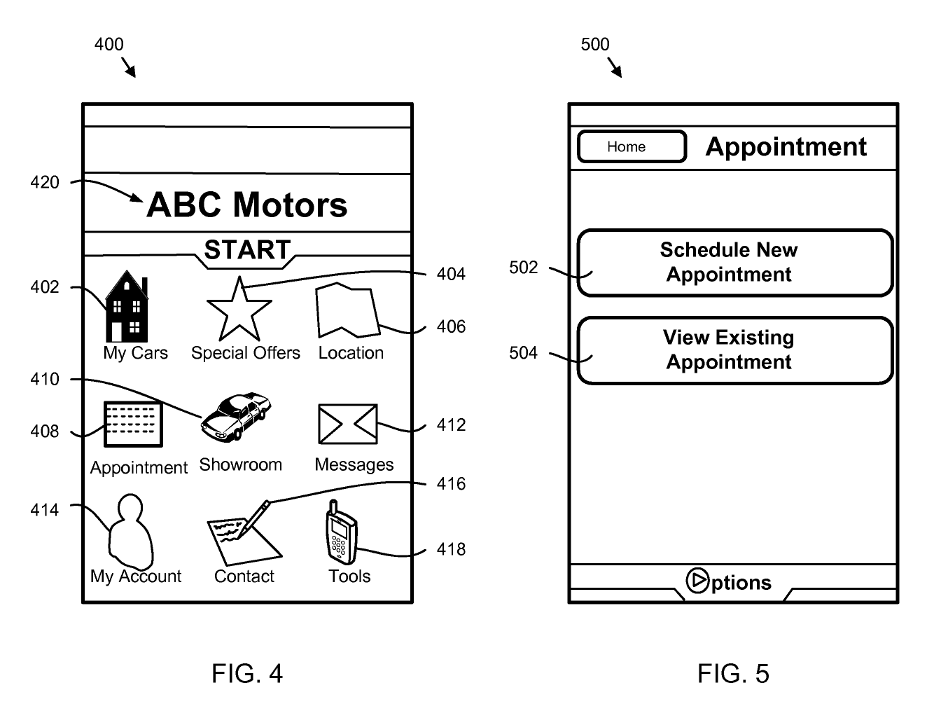

Turning now to FIG. 4 through FIG. 12, example screenshots of touch-screen interfaces displayed on a mobile computing device 104 are shown. The screen shots illustrate one example of interfaces for setting up and monitoring a service appointment from a mobile computing device 104. In one embodiment, the interfaces are provided by a mobile status module 300 that is installed as an application on the mobile computing device 104. One of skill in the art will recognize that the interfaces are exemplary only and can be modified considerably for different appearances, input devices, or the like without departing from the scope of the present disclosure.

FIG. 4 illustrates an example home screen interface 400. In one embodiment, the home screen interface 400 may be displayed when a corresponding mobile application is launched. The home screen interface 400 displays a number of icons 402-418 for accessing other portions of a mobile application. The icons include a my cars icon 402, a special offers icon 404, a location icon 406, an appointment icon 408, a showroom icon 410, a messages icon 412, a my account icon 414, a contact icon 416, and a tools icon 418. The depicted icons 402-418 and associated interfaces are given by way of example only. Fewer or additional icons or interfaces may be available in some embodiments. The home screen interface 400 also shows a store name 420 corresponding to a store which is a designated store within the mobile application.

The my cars icon 402 may be selected to display a my cars interface that shows a list of cars owned by a user or allow a user to add new cars. The special offers icon 404 may be selected to display a special offers interface for viewing special offers. The special offers may include offers provided in a lifecycle message from the messaging management system 112. The offers may correspond to offers available through a designated store, for example, the store corresponding to the store name 420.

The location icon 406 may be selected to locate a dealer, service station, or other store as a designated store for the application. For example, selection of a new store may change the store name 420 and other branding of the interfaces displayed in FIGS. 4-12. Additionally, each of the functions provided by the mobile status module 300 may be performed with respect to the designated store.

The appointment icon 408 may be selected to bring up an appointment interface to set up a service appointment. In one embodiment, the appointment interface may allow a user to select a date, time, vehicle, service, and/or service location for a service appointment. In one embodiment, the appointment interface may be used to correspond with the vehicle status system 102, messaging management system 112, or service center management system 114 to schedule the appointment with a specific service station or location.

The showroom icon 410 may be selected to bring up a vehicle search interface. The vehicle search interface may allow a user to browse and/or search for cars sold by one or more dealerships. For example, new and/or used inventory for the store indicated by the store name 420 may be viewable after selecting the showroom icon 410.

The messages icon 412 may be selected to bring up messages received from the vehicle status system 102, the messaging management system 112, the service center management system 114, or the third party-messaging system 116. In one embodiment, selection of the messages icon 412 may bring up an option to initiate a chat with an employee at a vehicle service center. For example, a user may be able to chat, provide image, audio, or video files to a technician or mechanic and receive feedback on what the user needs to do.

The my account icon 414 may be selected to bring up an account interface displaying account information for a user of the mobile computing device 104. For example, the account information may correspond to contact information determined by the contact module 202 of the vehicle status system 102. The account interface may also be used to modify or add account information.

The contact icon 416 may provide an interface with information for contacting a preferred store or service center, technical support, or other service provider. In one embodiment, the contact icon 416 may provide contact information, such as an address, email address, a chat option, or phone number for the preferred store.

The tools icon 418 may provide a variety of useful tools for a user. For example, various calculators, links, or phone functions may be provided within a tools interface to provide tools that may be needed by car shoppers or car owners.

FIG. 5 illustrates one embodiment of an appointment interface 500 resulting from selection of the appointment icon 408. The appointment interface 500 includes a schedule new appointment option 502 and a view existing appointment option 504. The schedule new appointment option 502 may display a new appointment interface to allow a user to schedule a new appointment with a designated store, for example a maintenance or repair service. The view existing appointment option 504 may display a status interface showing the status of a vehicle for an existing appointment or an appointment summary interface.

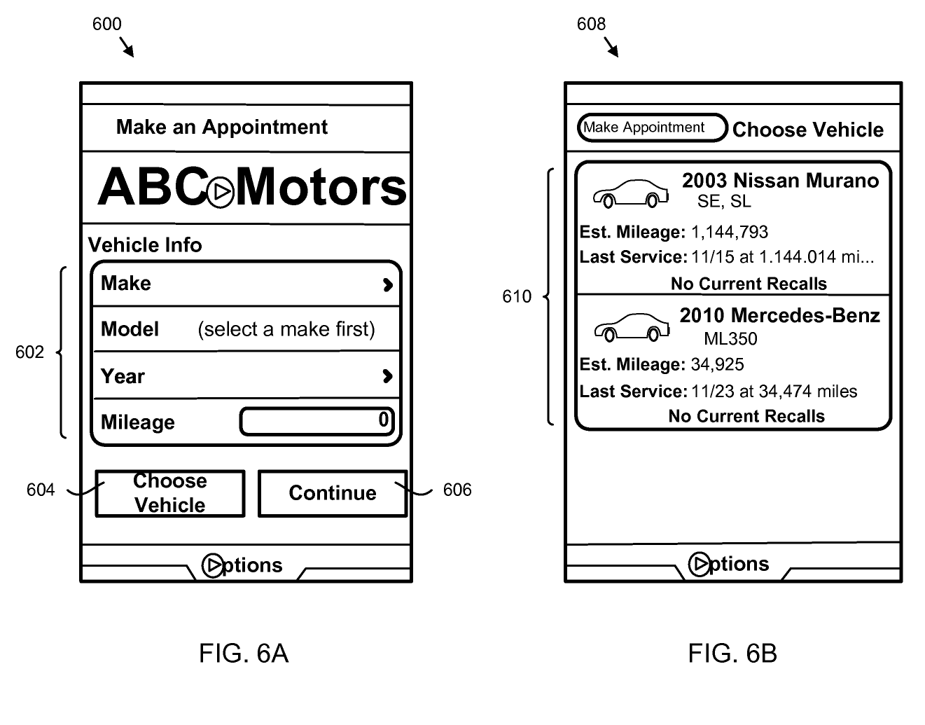

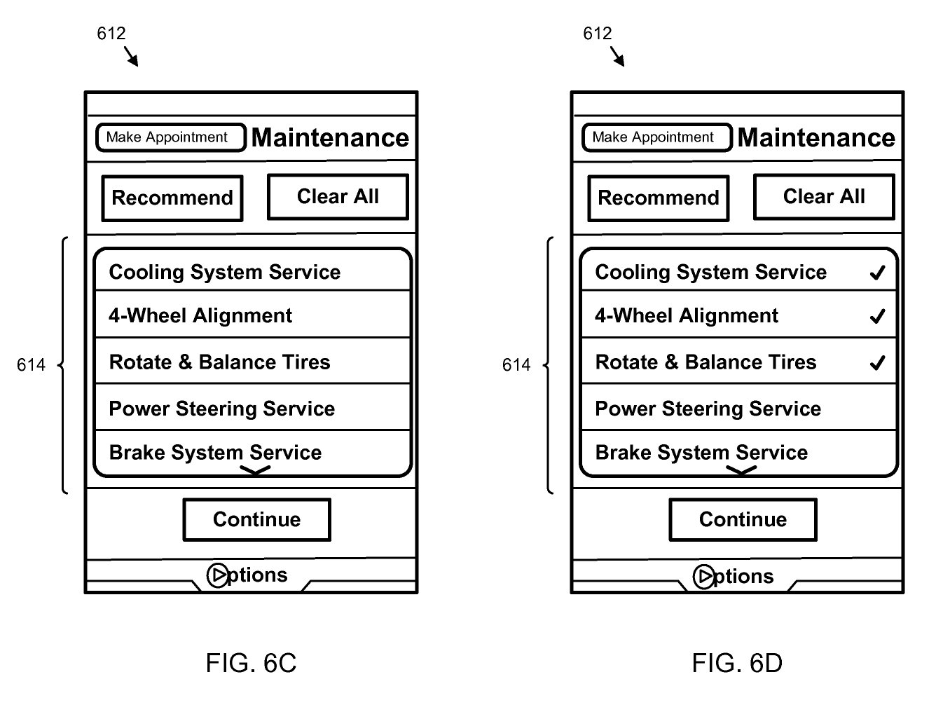

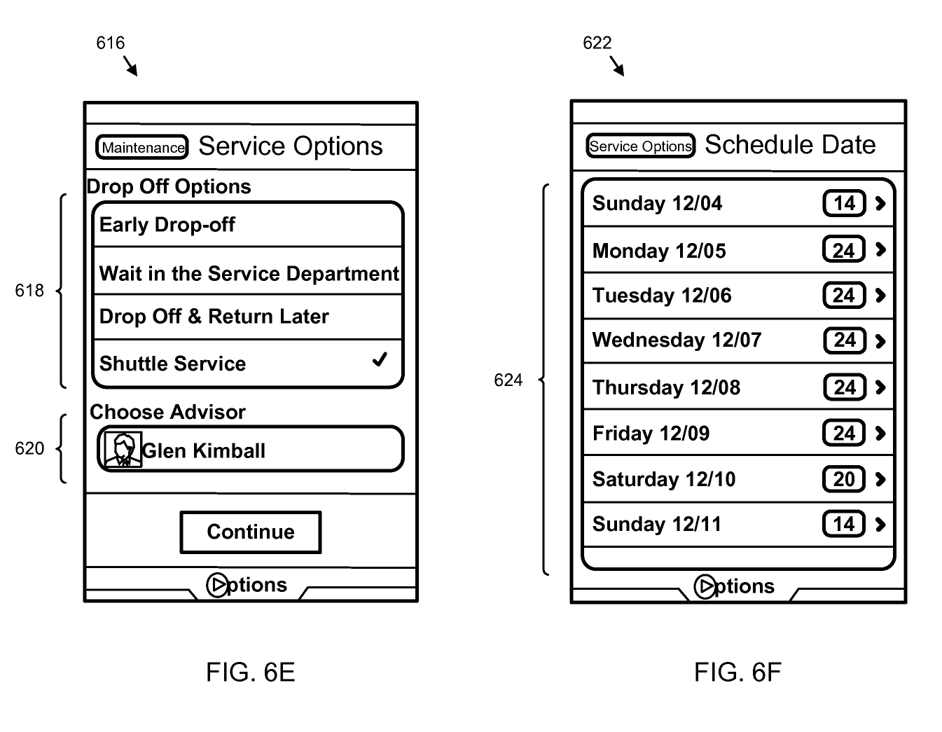

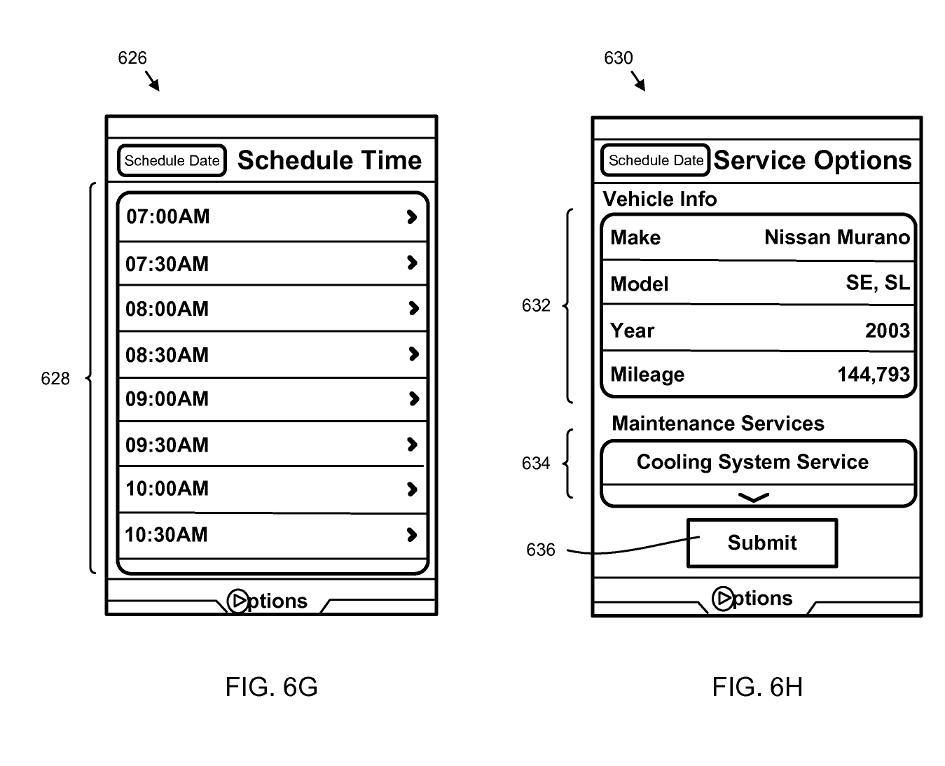

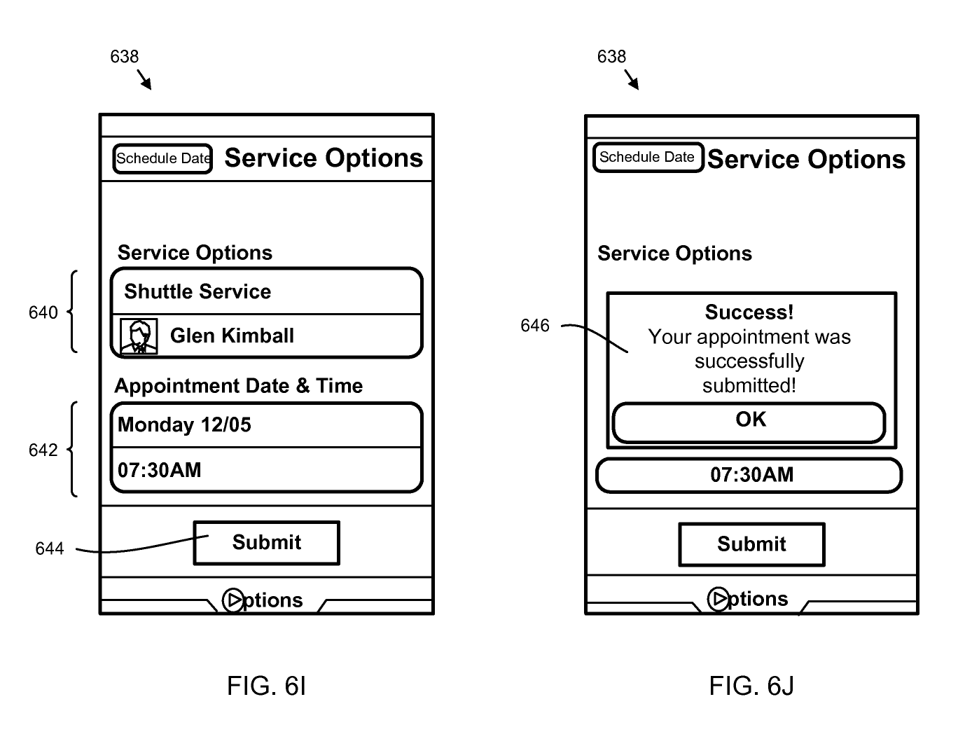

FIGS. 6A-6J illustrate one embodiment of a new appointment interface that may be displayed in response to selecting the schedule new appointment option 502 of FIG. 5. FIG. 6A illustrates a make an appointment interface 600 that includes a vehicle entry field 602, a choose vehicle option 604, and a continue option 606. The vehicle entry field 602 includes a number of fields to allow a user to provide information regarding a vehicle for which the user would like to schedule an appointment. A make field may display a list of vehicle makes that a user can select from. A model field may be selected to display a list of models corresponding to the selected make. For example, if a user chooses “Toyota”® as the make, the list of models may include Toyota® models such as Corolla®, Camry®, Tundra®, etc. The year field may be selected to provide a year of the vehicle and the mileage field may be selected to enter the current mileage of the vehicle.

FIG. 6B illustrates a choose vehicle interface 608 displayed in response to the choose vehicle option 604 of FIG. 6A. The choose vehicle interface 608 illustrates a vehicle list 610 showing vehicles that have already been entered. The vehicle list 610 includes a 2003 Nissan Murano® and a 2010 Mercedes-Benz®. A user may select the vehicle from the list for which the user wants to schedule an appointment. According to one embodiment, selection of a vehicle from the vehicle list 610 returns the user to the make an appointment interface 600 of FIG. 6A with the vehicle entry field 602 automatically populated with the details of the selected vehicle.

After selection of a vehicle or entry of vehicle details, a user may select the continue option 606 from the make an appointment interface 600 of FIG. 6A to continue with the scheduling of an appointment.

FIG. 6C illustrates a maintenance selection interface 612 which may be shown after selection of the continue option 606 in FIG. 6A. The maintenance selection interface 612 displays a number of maintenance options 614 which the user may select, for example, by touching the screen. The maintenance options 614 include a cooling system service, a 4-wheel alignment service, a rotate & balance tires service, a power steering service, a brake system service, and additional services may be viewed and/or selected by scrolling downward. FIG. 6D illustrates the maintenance selection interface 612 after a user has selected the cooling system service, the 4-wheel alignment service, and the rotate & balance tires service from the maintenance options 614. Checkboxes are illustrated next to each selected service.

In one embodiment, fewer, alternate, or additional services may be displayed in the maintenance options 614. For example, an oil change option, a repair option, or a custom option where a user may manually enter a description, may be selected.

FIG. 6E illustrates a service options interface 616 allowing a user to select from a list of drop off options 618 and choose advisor option 620. The service options interface 616 may be displayed after selection of the needed services as illustrated in FIGS. 6C and 6D. The drop off options 618 include an early drop-off option, a wait in the service department option, a drop off & return later option, and a shuttle service option. The shuttle service option, which requests that the service center drop off and/or pick up a customer at another location, is shown selected from the drop off options 618 list.

The choose advisor option 620 indicates that an advisor, Glen Kimball, is currently selected. A user may be able to select “Glen Kimball” and see information about the current advisor or view options for selecting a different advisor.

FIG. 6F illustrates a schedule date interface 622 where a user may select a day on which to schedule an appointment from a date list 624. The schedule date interface 622 may be displayed after selecting continue from the service options interface 616 of FIG. 6E. The dates and number of hours open on that day are shown. FIG. 6G illustrates a schedule time interface 626, which may be shown following selection of a date in the schedule date interface 622 of FIG. 6F. The schedule time interface 626 allows a user to select a time at which to schedule an appointment from a time list 628.

FIG. 6H illustrates a service options summary interface 630 that summarizes vehicle info 632 and selected services 634. The user can review the information before selecting a submit option 636. FIG. 6I illustrates an additional service option summary interface 638 that summarizes additional options 640 and the appointment date & time 642. The user can review the information before selecting a submit option 644. Selection of the submit option 644 may cause the appointment details to be sent from the mobile computing device 104 to a vehicle status system 102 to schedule the appointment with a service center management system 114. FIG. 6J illustrates a confirmation 646 on the service option summary interface 638 in response to submission and scheduling of the service appointment. In one embodiment, the confirmation 646 is provided following information from the vehicle status system 102 that the appointment was successfully scheduled.

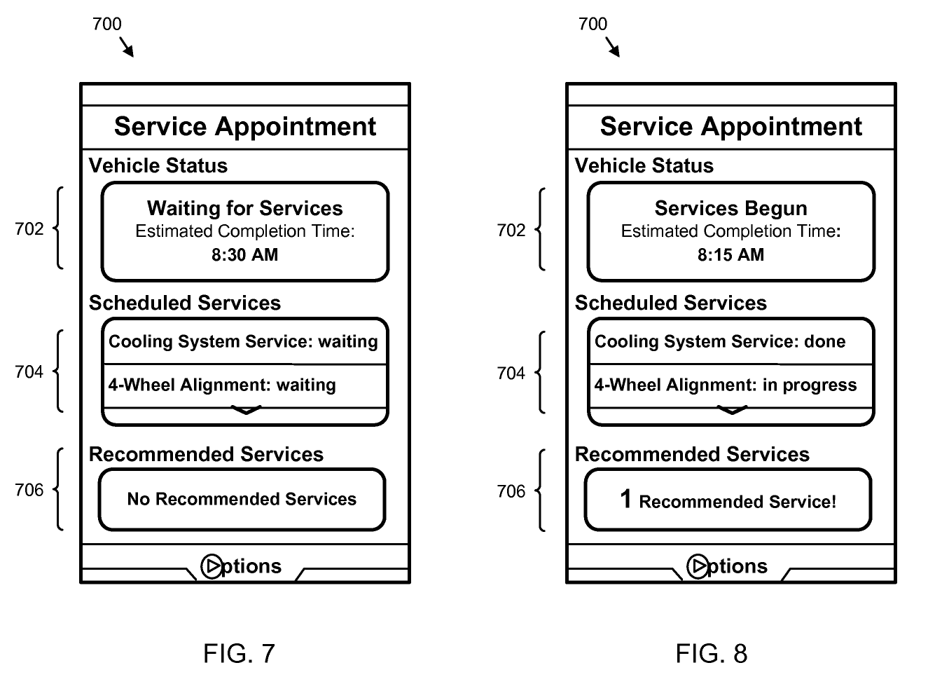

FIGS. 7-12 illustrate exemplary interfaces that may be displayed for a current appointment. For example, one or more of the interfaces of FIGS. 7-12 may be displayed in response to a user selecting the view existing appointment option 504 on FIG. 5.

FIG. 7 illustrates a status interface 700 that illustrates a status of a vehicle with regard to a service appointment. The status interface 700 provides a vehicle status 702, scheduled services status 704, and recommended services 706. The vehicle status 702 indicates that the vehicle is currently waiting for services and that the vehicle has an estimated completion time of 8:30 AM. The vehicle status 702 depicted within the interface 700 may be updated so that it reflects the currents status of the vehicle. For example, as services are begun, the status of the vehicle may change. The scheduled services status 704 lists the status of each scheduled service. A cooling system service and a 4-wheel alignment service are both listed as waiting. Additional scheduled services and their statuses may be viewed by scrolling down. The recommended services 706 currently include no recommended services.

FIG. 8 illustrates the status interface 700 of FIG. 7 after it has been updated. The vehicle status 702 has changed to indicate that services on the vehicle have begun and that the vehicle has an earlier completion time of 8:15 AM rather than 8:30 AM. The scheduled services status 704 has changed to indicate that the cooling system service has been completed and the 4-wheel alignment is currently in progress. The status of additional services may be viewed by scrolling down through the scheduled services status 704. The recommended services 706 have changed to indicate that there is one recommended service. In one embodiment, a user may select the recommended services 706 to view information regarding a recommended service.

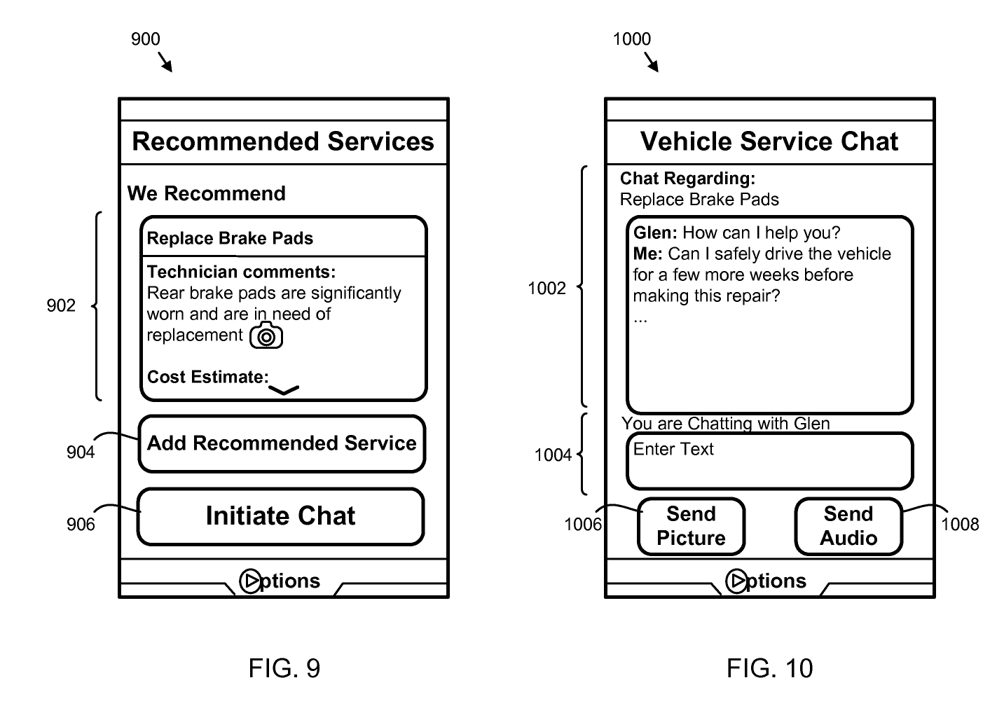

FIG. 9 illustrates a recommended services interface 900. The recommended services interface 900 may be displayed in response to a user selecting the recommended services 706 from FIG. 8. The recommended services interface 900 includes a description 902 that provides details regarding the recommended service. Specifically, the description 902 includes a name “Replace Brake Pads” as well as comments regarding why the service needs to be performed. Additional details may also be included, such as a cost estimate, estimated time the service would add to the appointment, options for the service, or other details. These details may include all information that a user might need to decide whether to perform the service and thus reduce the amount of questions a user may have and the amount of time the user and an employee must spend discussing the service.

The user may review the description 902 to determine if the user wishes to have the service performed during the current appointment, wait until later, or skip performance of the service. If the user decides to perform the service, the user may select the add recommended service option 904. If the user would like to get further details through a chat, the user may select the initiate chat option 906.

FIG. 10 illustrates a chat interface 1000 that may be displayed in response to the user selecting the initiate chat option 906 of FIG. 9. The chat interface 1000 includes a chat field 1002 which displays text or other information sent by parties to the chat. A text entry field 1004 is provided to allow a user to enter text. The chat interface 1000 also includes a send picture option 1006 and a send audio option 1008. Other options, such as options to attach a file or send a video may be included, in some embodiments.

The chat interface 1000 may allow a user and a technician or other vehicle service center employee to chat regarding the vehicle and what services are needed or other issues. The chat may allow a reduction of phone calls and may allow technicians to respond to questions or other issues when convenient, but still provide quick and helpful feedback to questions.

In addition to being used for discussing recommended services, the chat interface 1000 may be used for any questions the user may have. For example, a user may be able to initiate display of the chat interface 1000 by accessing the contact icon 416 of FIG. 4. Thus, the user may be able to chat with a technician regarding vehicle issues prior to bringing the vehicle in to the vehicle service center. Additionally, the user may be able to ask questions regarding costs of services, prepaid maintenance plans, or other services or products sold by the vehicle service center.

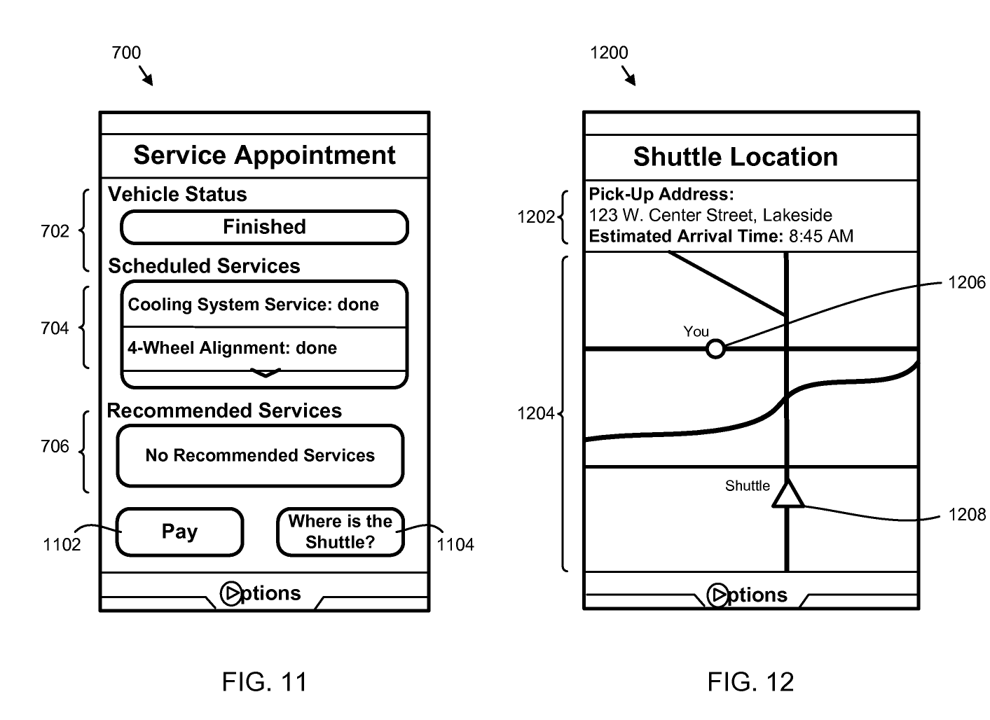

FIG. 11 illustrates the status interface 700 of FIGS. 7 and 8 after the user has added the recommended service and all services have been finished. The vehicle status 702 has changed to indicate that the vehicle is finished and/or ready for pick up. The scheduled services status 704 has changed to indicate that each of the services is done. The recommended services 706 have changed to indicate that there are no longer any additional recommended services. There may be no more recommended services because the user has added them as a scheduled service and/or the service has been performed.

The status interface 700 has also changed to provide a pay option 1102 and a shuttle option 1104. The user may select the pay option 1102 to be taken to a payment interface to initiate payment for the rendered services. For example, the user may be able to enter credit card information, select an account, or use a third-party intermediate account, such as a PayPal® account, to pay the fee. The user may select the shuttle location option 1104 to view a shuttle interface providing information regarding a location of a shuttle.

FIG. 12 illustrates a shuttle location interface 1200 that may be displayed in response to the user selecting the shuttle location option 1104. The shuttle location interface 1200 includes shuttle details 1202 and a location map 1204. The shuttle details 1202 illustrate the pick-up address that a shuttle is using and an estimated arrival time for the shuttle. The estimated arrival time may be based on a route to be taken by the shuttle, including intervening stops.

The location map 1204 illustrates a road map with the user location 1206 and the shuttle location 1208 indicated. In one embodiment, the user location 1206 may be the location of the individual based on a location determined by a GPS unit in the mobile computing device 104. In another embodiment, the user location 1206 indicates the pick-up address that is a destination of the shuttle.

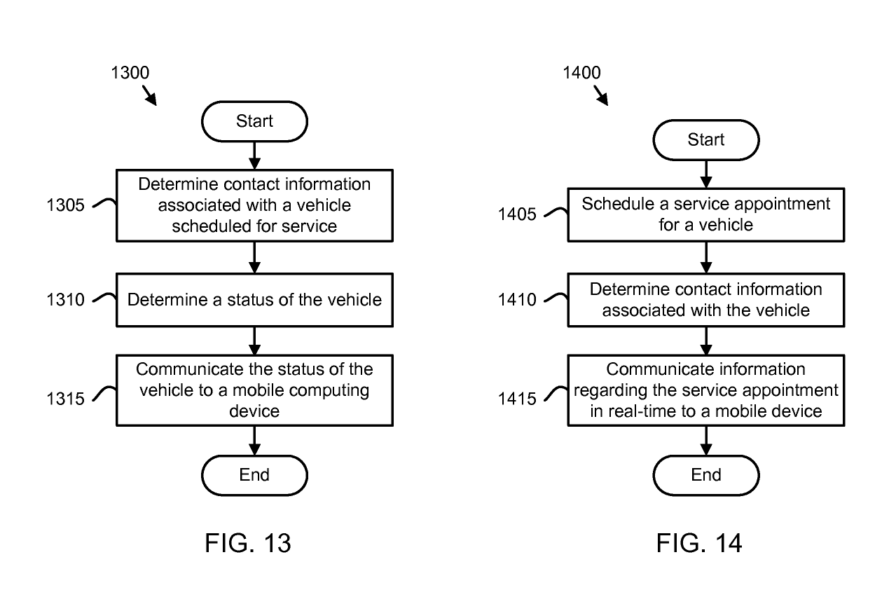

FIG. 13 is a schematic flow chart diagram illustrating a method 1300 for providing a vehicle status to a mobile computing device 104. In one embodiment, the method 1300 is performed by a vehicle status system 102.

The method 1300 includes a contact module 202 determining 1305 contact information associated with a vehicle scheduled for service. In one embodiment, the vehicle may be scheduled for service and the contact information corresponds to a mobile computing device 104. The contact information may include an account that has been linked to the vehicle and the mobile computing device 104. In one embodiment, the contact module 202 determines 1305 the contact information by looking up vehicle information or owner information in a database and locating corresponding contact information.

A status determination module 204 determines 1310 a status of the vehicle. The status determination module 204 may determine 1310 the status of the vehicle based on information provided by a vehicle service center employee, such as a technician, mechanic, or customer support representative. Alternatively or additionally, the status determination module 204 may determine 1310 a status based on sensors indicating a location of the vehicle or other information about the vehicle or service appointment.

The status determined 1310 by the status determination module 204 may include a status of a vehicle. For example, the status may include information regarding whether the vehicle is waiting for service, currently being serviced, or has been finished. Similarly, the status may include a status for each specific service that is planned or scheduled for the vehicle. In one embodiment, the status determined 1310 by the status determination module 204 may include information regarding a location of a shuttle, recommended services, or an option for payment.

A communication module 206 communicates 1315 the status of the vehicle to a mobile computing device 104. The status may be a status determined 1310 by the status determination module and the mobile computing device 104 may correspond to the contact information determined 1305 by the contact module 202. In one embodiment, the communication module 206 communicates 1315 the status in real-time to the mobile computing device 104. For example, a change in status may be communicated to the mobile computing device 104 within a defined time frame.

FIG. 14 is a schematic flow chart diagram illustrating a method 1400 for providing a vehicle status to a mobile computing device 104. In one embodiment, the method 1400 is performed by a vehicle status system 102.

A schedule module 208 schedules 1405 a service appointment for a vehicle. The schedule module 208 may schedule 1405 the appointment by receiving appointment information from a mobile computing device 104 and scheduling the service appointment within a calendar of a vehicle service center. In one embodiment, the schedule module 208 may schedule 1405 the service appointment for the vehicle with a service center management system 114. The schedule module 208 may also notify the mobile computing device 104 of the success in scheduling the service appointment.

Similar to method 1300 of FIG. 13, the method 1400 may include contact module 202 determining 1405 contact information associated with a vehicle scheduled for service. The method 1400 also includes a communication module 206 communicating 1415 status information for the vehicle to the mobile computing device 104 in real-time.

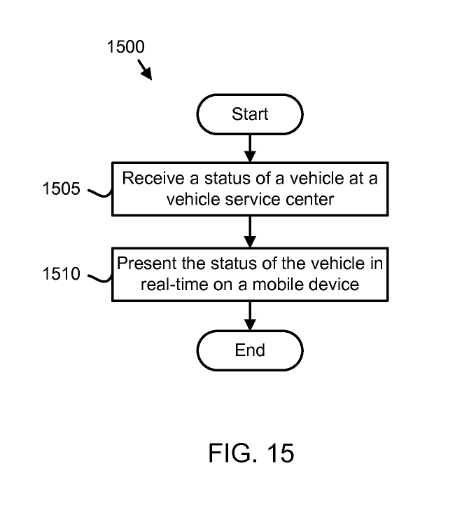

FIG. 15 is a schematic flow chart diagram illustrating a method 1500 for presenting a vehicle status on a mobile computing device 104. In one embodiment, the method 1500 is performed by a mobile status module 300. The mobile status module 300 may be a mobile application installed and running natively on a mobile computing device 104.

The method 1500 includes a status receipt module 306 receiving 1505 a status of a vehicle at a vehicle service center. The vehicle may be scheduled for service and the status of the vehicle may be received based on information provided by the vehicle service center. In one embodiment, the status receipt module 306 receives 1505 a status in real-time. The status receipt module 306 may cause the mobile computing device 104 to communicate with the vehicle service center in real-time. For example, the status receipt module 306 may receive 1505 messages from a vehicle status system 102 located at the vehicle service center or may receive 1505 messages from a vehicle status system 102 that is relaying messages based on information received from the vehicle service center in real-time.

The method 1500 includes a status interface module 308 presenting 1510 a received status on the mobile computing device 104. For example, the status interface module 308 may present 1510 the status on a display screen of the mobile computing device 104 so that a user can see the status of the vehicle. That status may include a completion status of the vehicle or of one or more services scheduled for the vehicle.

Some of the components that can be used with embodiments disclosed herein are already available, such as general-purpose computers, mobile phones, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device, such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module may include any type of computer instruction or computer executable code located within or on a non-transitory computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined, at least in part, by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

One of ordinary skill in the art will appreciate that various modifications and changes can be made without departing from the scope of the present disclosure. For example, various operational functions, as well as components for carrying out operational functions, may be implemented in alternate ways depending upon the particular application or in consideration of any number of cost functions associated with the operation of the system. Accordingly, any one or more of the functions may be deleted, modified, or combined with other functions. Further, this disclosure is to be regarded in an illustrative rather than a restrictive sense, and all such modifications are intended to be included within the scope thereof. Likewise, benefits, other advantages, and solutions to problems have been described above with regard to various embodiments. However, any benefit, advantage, solution to problems, and any element(s) that may cause any benefit, advantage, or solution to occur or become more pronounced, are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements, but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

It will be obvious to those having skill in the art that many changes may be made to the details of the above-described embodiments without departing from the underlying principles of the invention. The scope of the present invention should, therefore, be determined only by the following claims.

1. A vehicle status computer system comprising:
a processor;
a memory in electrical communication with the processor and having stored thereon computer executable instruction code, comprising:
a contact module that determines contact information associated with a vehicle scheduled for service at a vehicle service center, the contact information corresponding to a mobile computing device, wherein the mobile computing device comprises a mobile application provided by a third party, the mobile application installed on the mobile computing device;
a status determination module that determines a status of the vehicle;
a shuttle module that determines a current location of a shuttle vehicle and an estimated arrival time at a pick-up location, wherein the shuttle module determines the estimated arrival time based on a current location of the shuttle vehicle and one or more intervening stops for the shuttle vehicle enroute to the pick-up location, wherein the shuttle module is configured to automatically determine the estimated arrival time in response to determining that service on the vehicle is complete; and
a communication module that communicates the status of the vehicle to the mobile computing device using push notifications to the mobile computing device, wherein the communication module further communicates the current location and the estimated arrival time of the shuttle vehicle in real-time to the mobile computing device.

2. The system of claim 1, wherein the communication module communicates the status of the vehicle in real-time.

3. The system of claim 2, wherein the status information is communicated between the vehicle service center and the mobile computing device in real-time.

4. The system of claim 1, wherein the status determination module determines the status comprising a location of the vehicle at the service center.

5. The system of claim 1, wherein the status determination module determines the status comprising a completion status of a scheduled service.

6. The system of claim 5, wherein the completion status comprises information indicating that the scheduled service is completed.

7. The system of claim 5, wherein the completion status comprises information indicating that the scheduled service is currently being performed.

8. The system of claim 5, wherein the completion status comprises information indicating that the scheduled service has not begun.

9. The system of claim 1, wherein the status determination module determines the status comprising a predicted completion time for one or more scheduled services.

10. The system of claim 1, wherein the status determination module determines the status comprising a suggested service.

11. The system of claim 1, wherein the status determination module determines the status based on input received from a technician at the vehicle service center.

12. The system of claim 1, wherein the contact information comprises account information corresponding to the mobile computing device.

13. The system of claim 1, wherein the contact module determines contact information comprising information regarding a vehicle service account.

14. The system of claim 1, wherein the contact module determines contact information comprising information regarding a user account linked to the mobile computing device.

15. A method comprising:
scheduling, one or more processors, a service appointment for a vehicle at a vehicle service center;
determining, by the one or more processors, contact information associated with the vehicle, the contact information corresponding to a mobile computing device comprising a mobile application installed on the mobile computing device;
determining, by the one or more processors, a status of the vehicle;
automatically calculating, by the one or more processors, an estimated arrival time of a shuttle at a pick-up location based on a current location of the shuttle and one or more intervening stops of the shuttle in response to determining that service on the vehicle is being completed; and
communicating, in real-time the one or more processors, information regarding the service status of the vehicle and the estimated arrival time of the shuttle at the pick-up location to the mobile computing device using pull or push notifications to the mobile application.

16. The method of claim 15, wherein communicating in real-time comprises communicating a status of the vehicle to the mobile computing device.

17. The method of claim 16, wherein communicating the status comprises repeatedly communicating the status during a duration of the service appointment.

18. The method of claim 15, wherein communicating in real-time comprises communicating information corresponding to a chat session between a representative at the vehicle service center and a user on the mobile computing device.

19. The method of claim 15, wherein communicating in real-time comprises communicating one or more of video, audio, and images of the vehicle at the vehicle service station to the mobile computing device.

20. The method of claim 15, wherein communicating in real-time comprises providing a suggestion for additional services to the mobile computing device.

21. The method of claim 15, further comprising receiving, in real-time, information regarding the service appointment from the mobile computing device.

22. The method of claim 21, wherein receiving information regarding the service appointment comprises receiving approval for additional services.

23. The method of claim 21, wherein receiving information regarding the service appointment comprises receiving a query regarding the service appointment.

24. The method of claim 15, wherein communicating in real-time comprises communicating information regarding a current location of a shuttle to the mobile computing device.

25. The method of claim 15, wherein communicating in real-time comprises communicating information to prompt for payment in response to completion of scheduled services.

26. A mobile computing device comprising:
at least one processor;
a memory in electrical communication with the processor and having stored thereon computer executable instruction code corresponding to a mobile application installed on the mobile computing device, the computer executable instruction code comprising:
a mobile communication module configured to communicate with a vehicle service center;
a status receipt module that receives pull or push notifications comprising a status of a vehicle from the vehicle service center, the vehicle scheduled for service at a vehicle service center; and
a status interface module that presents the status of the vehicle on the mobile computing device, wherein the status interface module is configured to present the status of the vehicle in real-time, wherein the status information module is further configured to automatically display an estimated arrival time of a shuttle vehicle based on a current location of the shuttle vehicle and one or more scheduled, intervening stops of the shuttle vehicle, in response to the status indicating that service on the vehicle is complete.

27. The mobile computing device of claim 26, wherein the presentation module provides an option to initiate a chat with a technician at the vehicle service center.

28. The mobile computing device of claim 27, further comprising a chat interface module that displays a chat interface.

29. The mobile computing device of claim 26, further comprising a shuttle interface module to display a shuttle location interface.

30. The mobile computing device of claim 29, wherein the shuttle interface module displays a shuttle location interface comprising a map illustrating a current location of the shuttle.

31. The mobile computing device of claim 29, wherein the shuttle interface module displays a shuttle location interface comprising an arrival time for the shuttle.

32. The mobile computing device of claim 26, wherein the presentation module presents a payment option.

33. The mobile computing device of claim 32, wherein the payment option is provided in response to receiving a status indicating that service on the vehicle is finished.

34. The mobile computing device of claim 32, further comprising a payment interface module to display a payment interface that allows a user to initiate payment.

35. The mobile computing device of claim 26, further comprising an appointment scheduler interface module to allow a user to schedule a service appointment from the mobile computing device.
